(19) United States
(12) Patent Application Publication
(10) Pub. No.: US 2014/0165549 A1
(43) Pub. Date: Jun. 19, 2014

(54) HYDRAULIC SYSTEM HAVING MULTIPLE CLOSED LOOP CIRCUITS

(71) Applicant: CATERPILLAR INC., Peoria, IL (US)

(72) Inventors: Magomed GABIBULAYEV, Dunlap, IL (US); Jeffrey L. KUEHN, Germantown Hills, IL (US); Michael L. KNUSSMAN, East Peoria, IL (US); Jeremy T. PETERSON, Washington, IL (US); Viral S. MEHTA, Peoria, IL (US); Benjamin T. NELSON, Dunlap, IL (US)

(73) Assignee: CATERPILLAR INC., Peoria, IL (US)

(21) Appl. No.: 13/720,229

(22) Filed: Dec. 19, 2012

(51) Int. Cl. F15B 21/00

(52) U.S. Cl. CPC F15B 21/001
USPC 60/421

(57) ABSTRACT

A hydraulic system is disclosed. The hydraulic system may have a first pump, a boom cylinder, and a first closed loop fluidly connecting the first pump to the boom cylinder. The hydraulic system may also have a second pump, a swing motor, and a second closed loop fluidly connecting the second pump to the swing motor. The hydraulic system may further have a third pump, an auxiliary actuator, and a third closed loop fluidly connecting the third pump to the auxiliary actuator. The hydraulic system may additionally have a combining valve configured to selectively connect the second closed loop to the first closed loop during a boom raising operation, and a control valve configured to selectively connect the third closed loop to the first closed loop during a boom lowering operation.

### TECHNICAL FIELD

The present disclosure relates generally to a hydraulic system and, more particularly, to a hydraulic system having multiple closed loop circuits.

### BACKGROUND

A conventional hydraulic system includes a pump that draws low-pressure fluid from a tank, pressurizes the fluid, and makes the pressurized fluid available to multiple different actuators for use in moving the actuators. In this arrangement, a speed of each actuator can be independently controlled by selectively throttling (i.e., restricting) a flow of the pressurized fluid from the pump into each actuator. For example, to move a particular actuator at a high speed, the flow of fluid from the pump into the actuator is restricted by only a small amount (or not at all). In contrast, to move the same or another actuator at a low speed, the restriction placed on the flow of fluid is increased. Although adequate for many applications, the use of fluid restriction to control actuator speed can result in pressure losses that reduce an overall efficiency of a hydraulic system.

An alternative type of hydraulic system is known as a closed loop hydraulic system. A closed loop hydraulic system generally includes a pump connected in closed loop fashion to a single actuator or to a pair of actuators operating in tandem. During operation, the pump draws fluid from one chamber of the actuator(s) and discharges pressurized fluid to an opposing chamber of the same actuator(s). To move the actuator(s) at a higher speed, the pump discharges fluid at a faster rate. To move the actuator(s) with a lower speed, the pump discharges the fluid at a slower rate. A closed loop hydraulic system is generally more efficient than a conventional hydraulic system because the speed of the actuator(s) is controlled through pump operation as opposed to fluid restriction. That is, the pump is controlled to only discharge as much fluid as is necessary to move the actuator(s) at a desired speed, and no throttling of a fluid flow is required.

An exemplary closed loop hydraulic system is disclosed in U.S. Pat. No. 4,369,625 of Izumi et al. that published on Jan. 25, 1983 (the '625 patent). In the '625 patent, a multi-actuator meterless-type hydraulic system is described that has flow combining functionality. The hydraulic system includes a swing circuit, a boom circuit, a stick circuit, a bucket circuit, a left travel circuit, and a right travel circuit. Each of the swing, boom, stick, and bucket circuits have a pump connected to a specialized actuator in a closed loop manner. In addition, a first combining valve is connected between the swing and stick circuits, a second combining valve is connected between the stick and boom circuits, and a third combining valve is connected between the bucket and boom circuits. The left and right travel circuits are connected in parallel to the pumps of the bucket and boom circuits, respectively. In this configuration, any one actuator can receive pressurized fluid from more than one pump such that its speed is not limited by the capacity of a single pump.

Although an improvement over existing closed loop hydraulic systems, the closed loop hydraulic system of the '625 patent described above may still be less than optimal. In particular, operation of connected circuits of the system may only be sequentially performed. In addition, the speeds and forces of the various actuators may be difficult to control.

The hydraulic system of the present disclosure is directed toward solving one or more of the problems set forth above and/or other problems of the prior art.

### SUMMARY

In one aspect, the present disclosure is directed to a hydraulic system. The hydraulic system may include a first pump, a boom cylinder, and a first closed loop fluidly connecting the first pump to the boom cylinder. The hydraulic system may also have a second pump, a swing motor, and a second closed loop fluidly connecting the second pump to the swing motor. The hydraulic system may further have a third pump, an auxiliary actuator, and a third closed loop fluidly connecting the third pump to the auxiliary actuator. The hydraulic system may additionally have a combining valve configured to selectively connect the second closed loop to the first closed loop during a boom raising operation, and a control valve configured to selectively connect the third closed loop to the first closed loop during a boom lowering operation.

In another aspect, the present disclosure is directed to a method of operating a hydraulic system. The method may include pressurizing fluid with a first pump, and directing pressurized fluid from the first pump into and out of a boom cylinder via a first closed loop to move the boom cylinder. The method may also include pressurizing fluid with a second pump, and directing pressurized fluid from the second pump through a swing motor via a second closed loop to move the swing motor. The method may further include pressurizing fluid with a third pump, and directing pressurized fluid from the third pump into and out of an auxiliary actuator to move the auxiliary actuator. The method may additionally include selectively directing pressurized fluid from the second pump into the boom cylinder during a boom raising operation, and selectively directing fluid from the boom cylinder to the third pump during a boom lowering operation.

### BRIEF DESCRIPTION OF THE DRAWINGS

FIG. 1 is a pictorial illustration of an exemplary disclosed machine; and

FIG. 2 is a schematic illustration of an exemplary disclosed hydraulic system that may be used in conjunction with the machine of FIG. 1.

### DETAILED DESCRIPTION

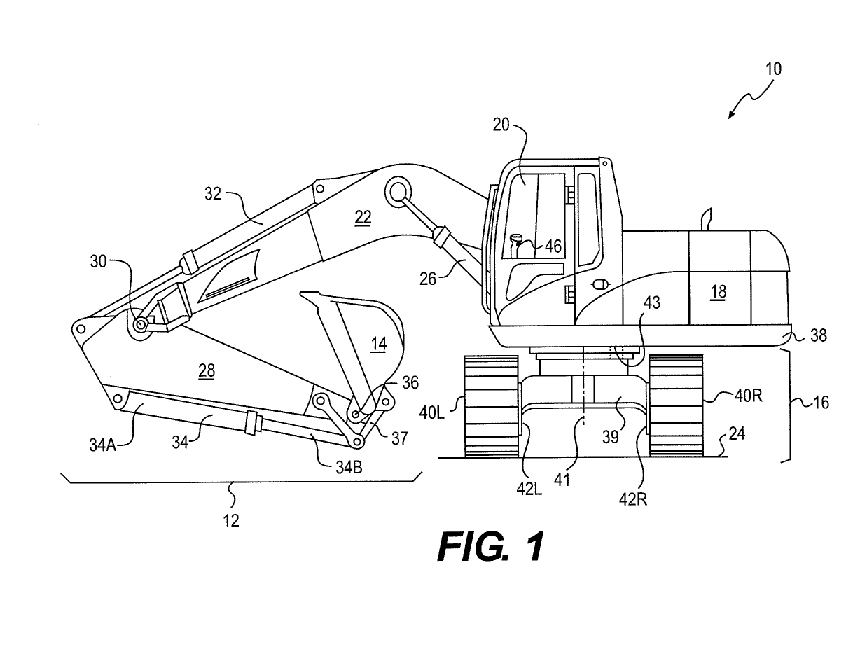

FIG. 1 illustrates an exemplary machine 10 having multiple systems and components that cooperate to accomplish a task. Machine 10 may embody a fixed or mobile machine that performs some type of operation associated with an industry such as mining, construction, farming, transportation, or another industry known in the art. For example, machine 10 may be an earth moving machine such as an excavator (shown in FIG. 1), a dozer, a loader, a backhoe, a motor grader, a dump truck, or any other earth moving machine. Machine 10 may include an implement system 12 configured to move a work tool 14, a drive system 16 for propelling machine 10, a power source 18 that provides power to implement system 12 and drive system 16, and an operator station 20 situated for manual control of implement system 12, drive system 16, and/or power source 18.

Implement system 12 may include a linkage structure acted on by fluid actuators to move work tool 14. Specifically, implement system 12 may include a boom 22 that is vertically pivotal about a horizontal axis (not shown) relative to a work surface 24 by a pair of adjacent, double-acting, hydraulic cylinders 26 (only one shown in FIG. 1). Implement system 12 may also include a stick 28 that is vertically pivotal about a horizontal axis 30 by a single, double-acting, hydraulic cylinder 32. Implement system 12 may further include a single, double-acting, hydraulic cylinder 34 that is operatively connected between stick 28 and work tool 14 to pivot work tool 14 vertically about a horizontal pivot axis 36. In the disclosed embodiment, hydraulic cylinder 34 is connected at a head-end 34A to a portion of stick 28 and at an opposing rod-end 34B to work tool 14 by way of a power link 37. Boom 22 may be pivotally connected to a body 38 of machine 10. Body 38 may be pivotally connected to an undercarriage 39 and movable about a vertical axis 41 by a hydraulic swing motor 43. Stick 28 may pivotally connect boom 22 to work tool 14 by way of axis 30 and 36. It is contemplated that a different number and/or configuration of actuators may alternatively be included within implement system 12 in the same or a different manner than described above, if desired.

Numerous different work tools 14 may be attachable to a single machine 10 and operator controllable. Work tool 14 may include any device used to perform a particular task such as, for example, a bucket, a fork arrangement, a blade, a shovel, a ripper, a dump bed, a broom, a snow blower, a propelling device, a cutting device, a grasping device, or any other task-performing device known in the art. Although connected in the embodiment of FIG. 1 to pivot in the vertical direction relative to body 38 of machine 10 and to swing in the horizontal direction, work tool 14 may alternatively or additionally rotate, slide, open and close, or move in any other manner known in the art.

Drive system 16 may include one or more traction devices powered to propel machine 10. In the disclosed example, drive system 16 includes a left track 40L located at one side of machine 10, and a right track 40R located at an opposing side of machine 10. Left track 40L may be driven by a left-travel motor 42L, while right track 40R may be driven by a right-travel motor 42R. It is contemplated that drive system 16 could alternatively include traction devices other than tracks such as wheels, belts, or other known traction devices. Machine 10 may be steered by generating a speed and/or rotational direction difference between left and right-travel motors 42L, 42R, while straight travel may be facilitated by generating substantially equal output speeds and rotational directions from left and right-travel motors 42L, 42R.

Power source 18 may embody an engine such as, for example, a diesel engine, a gasoline engine, a gaseous fuel-powered engine, or any other type of combustion engine known in the art. It is contemplated that power source 18 may alternatively embody a non-combustion source of power such as a fuel cell, a power storage device, a tethered motor, or another source known in the art. Power source 18 may produce a mechanical or electrical power output that may then be converted to hydraulic power for moving hydraulic cylinders 26, 32, 34 and left travel, right travel, and swing motors 42L, 42R, 43.

Operator station 20 may include devices that receive input from a machine operator indicative of desired machine maneuvering. Specifically, operator station 20 may include one or more operator interface devices 46, for example a joystick, a steering wheel, or a pedal, that are located proximate an operator seat (not shown). Operator interface devices 46 may initiate movement of machine 10, for example travel and/or tool movement, by producing displacement signals that are indicative of desired machine maneuvering. As an operator moves interface device 46, the operator may affect a corresponding machine movement in a desired direction, with a desired speed, and/or with a desired force.

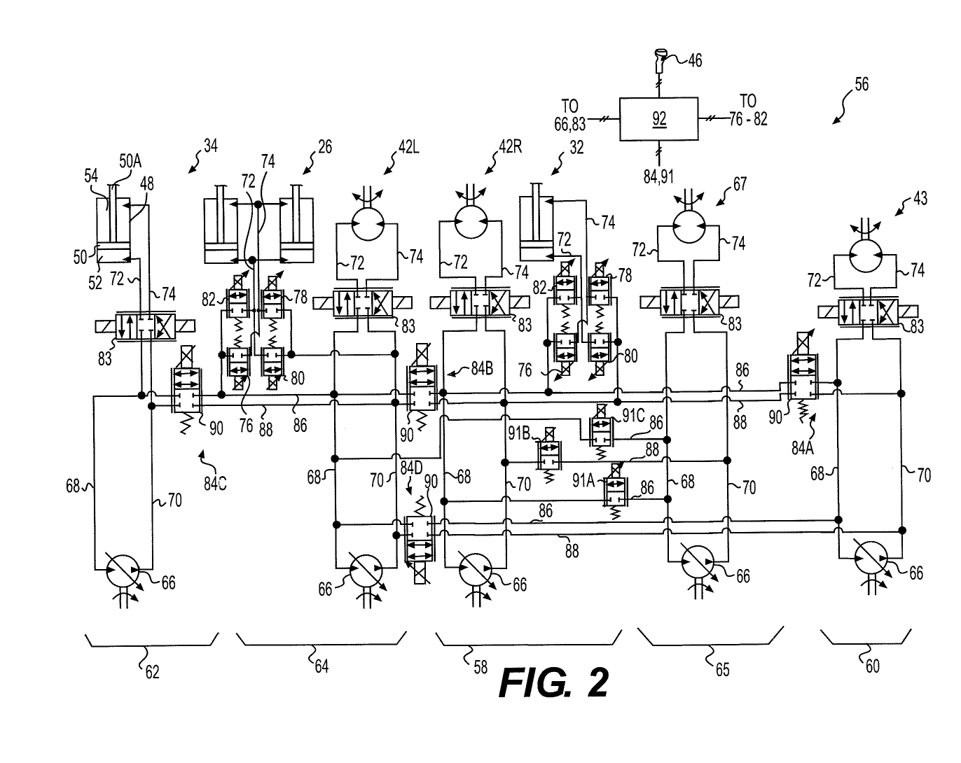

As shown in FIG. 2, hydraulic cylinders 26, 32, 34 may each include a tube 48 and a piston assembly 50 arranged within tube 48 to form a first chamber 52 and an opposing second chamber 54. In one example, a rod portion 50A of piston assembly 50 may extend through an end of second chamber 54. As such, second chamber 54 may be considered the rod-end chamber of hydraulic cylinders 26, 32, 34, while first chamber 52 may be considered the head-end chamber.

First and second chambers 52, 54 may each be selectively supplied with pressurized fluid and drained of the pressurized fluid to cause piston assembly 50 to displace within tube 48, thereby changing an effective length of hydraulic cylinders 26, 32, 34 and moving work tool 14 (referring to FIG. 1). A flow rate of fluid into and out of first and second chambers 52, 54 may relate to a translational velocity of hydraulic cylinders 26, 32, 34, while a pressure differential between first and second chambers 52, 54 may relate to a force imparted by hydraulic cylinders 26, 32, 34 on the associated linkage structure of implement system 12.

Left travel, right travel, and swing motors 42L, 42R, 43, like hydraulic cylinders 26, 32, 34, may each be driven by a fluid pressure differential. Specifically, each of these motors may include first and second chambers (not shown) located to either side of a corresponding pumping mechanism such as an impeller, plunger, or series of pistons (not shown). When the first chamber is filled with pressurized fluid and the second chamber is drained of fluid, the pumping mechanism may be urged to move or rotate in a first direction. Conversely, when the first chamber is drained of fluid and the second chamber is filled with pressurized fluid, the pumping mechanism may be urged to move or rotate in an opposite direction. The flow rate of fluid into and out of the first and second chambers may determine an output velocity of the respective motor, while a pressure differential across the pumping mechanism may determine an output torque. Although shown in FIG. 2 as being fixed displacement bi-directional motors, it is contemplated that a displacement of left travel, right travel, and/or swing motors 42L, 42R, 43 may alternatively be variable and of an over-center type, if desired. In the alternative embodiment, these motors may be provided with controls and equipment to support a load when changing displacement directions, such that for a given flow rate and/or pressure of supplied fluid, a speed and/or torque output of each motor may be independently adjusted.

As also illustrated in FIG. 2, machine 10 may include a hydraulic system 56 having a plurality of circuits that drive the fluid actuators described above to move work tool 14 (referring to FIG. 1) and machine 10. In particular, hydraulic system 56 may include, among other things, a first circuit 58, a second circuit 60, a third circuit 62, a fourth circuit 64, and a fifth circuit 65. First circuit 58 may be primarily associated with hydraulic cylinder 32 and right-travel motor 42R. Second circuit 60 may be primarily associated with swing motor 43. Third circuit 62 may be primarily associated with hydraulic cylinder 34. Fourth circuit 64 may be primarily associated with left travel motor 42L and hydraulic cylinders 26. Fifth circuit 65 may be primarily associated with an auxiliary actuator 67, for example an auxiliary motor (shown) or cylinder (not shown) directly associated with work tool 14. It is contemplated that additional and/or different configurations of circuits may be included within hydraulic system 56 such as, for example, a charge circuit associated with each of circuits 58-65, and/or an independent circuit associated with hydraulic cylinders 26 or 34, if desired.

In the disclosed embodiment, each of circuits 58-65 may be similar and include a plurality of interconnecting and cooperating fluid components that facilitate the use and control of the associated actuators. For example, each of circuit 58-65 may include a pump 66 fluidly connected to its associated actuator(s) via a closed loop formed by left-side and right-side (relative to FIG. 2) passages. Specifically, each of circuits 58-65 may include a common left pump passage 68, a common right pump passage 70, a left actuator passage 72 for each actuator, and a right actuator passage 74 for each actuator. In circuits having linear actuators (e.g., hydraulic cylinders 26, 32, or 34), left and right actuator passages 72, 74 may be commonly known as head-end and rod-end passages, respectively. Within each circuit 58-65, the corresponding pump 66 may be connected to its associated actuators via a combination of left and right, pump and actuator passages 68-74.

To cause a rotary actuator (e.g., left-travel, right-travel, swing, and/or auxiliary motor 42L, 42R, 43) to rotate in a first direction, left actuator passage 72 of a particular circuit may be filled with fluid pressurized by pump 66, while the corresponding right actuator passage 74 may be filled with fluid exiting the rotary actuator. To reverse direction of the rotary actuator, right actuator passage 74 may be filled with fluid pressurized by pump 66, while left actuator passage 72 may be filled with fluid exiting the rotary actuator.

To retract a linear actuator (e.g., hydraulic cylinders 26, 32, or 34), right actuator passage 74 of a particular circuit may be filled with fluid pressurized by pump 66, while corresponding left actuator passage 72 may be filled with fluid returned from the linear actuator. In contrast, to extend the linear actuator, left actuator passage 72 may be filled with fluid pressurized by pump 66, while right actuator passage 74 may be filled with fluid exiting the linear actuator.

Each pump 66 may have variable displacement and be controlled to draw fluid from its associated actuators and discharge the fluid at a specified elevated pressure back to the actuators in a single direction. That is, pump 66 may include a stroke-adjusting mechanism, for example a swashplate, a position of which is hydro-mechanically adjusted based on, among other things, a desired speed of the actuators to thereby vary an output (e.g., a discharge rate) of pump 66. The displacement of pump 66 may be adjusted from a zero displacement position at which substantially no fluid is discharged from pump 66, to a maximum displacement position at which fluid is discharged from pump 66 at a maximum rate into right pump passage 70. Pump 66 may be drivably connected to power source 18 of machine 10 by, for example, a countershaft, a belt, or in another suitable manner. Alternatively, pump 66 may be indirectly connected to power source 18 via a torque converter, a gear box, an electrical circuit, or in any other manner known in the art. It is contemplated that pumps 66 of different circuits may be connected to power source 18 in tandem (e.g., via the same shaft) or in parallel (via a gear train), as desired.

Pumps 66 may also be selectively operated as motors. More specifically, when an associated actuator is operating in an overrunning condition, the fluid discharged from the actuator may have a pressure elevated higher than an output pressure of the corresponding pump 66. In this situation, the elevated pressure of the actuator fluid directed back through pump 66 may function to drive pump 66 to rotate with or without assistance from power source 18. Under some circumstances, pump 66 may even be capable of imparting energy to power source 18, thereby improving an efficiency and/or capacity of power source 18.

During some operations, it may be desirable to cause movement of one particular actuator independent of movement of another associated actuator within the same circuit. For this purpose, each of circuits 58 and 64 may be provided with at least one metering valve that is capable of substantially isolating a particular actuator from its associated pump 66 and/or other actuators of the same circuit. In some instances, the metering valve(s) may also be capable of independently controlling a speed of the associated actuator. In the disclosed embodiment, each of circuits 58 and 64 includes a set of four independent metering valves for one of the paired actuators in each circuit, including a first metering valve 76, a second metering valve 78, a third metering valve 80, and a fourth metering valve 82. First and second metering valves 76, 78 may be configured to regulate fluid flow into and out of one side of the corresponding actuator (e.g., into and out of second chamber 54 of a linear actuator). Third and fourth metering valves 80, 82 may be configured to similarly control fluid flow into and out of a second side of the associated actuator (e.g., into and out of first chamber 52). First and fourth metering valves 76, 82 may be associated with left pump passage, while second and third metering valves 78, 80 may be associated with right pump passage 70.

During operation, one of first and second metering valves 76, 78 and one of third and fourth metering valves 80, 82 will generally be passing fluid, while the remaining valves will generally be blocking fluid flow. And of the valves that are passing fluid, one will generally be passing fluid into the associated actuator, while the other will generally be passing fluid out of the associated actuator. In this manner, each set of four metering valves 76-82 may be utilized together to control a speed (through variable restriction of supply and return fluid flows) and a movement direction (through selective control of which of the valves are passing and blocking flow) of the associated actuator.

Each metering valve 76-82 may include a valve element movable to any position between a fully-open or flow-passing position and a fully-closed or flow-blocking position. Each metering valve 76-82 may be spring-biased toward the flow-blocking position and solenoid-operated to move toward the flow-passing position. It is contemplated that other configurations of valves may be utilized to meter fluid into and/or out of the actuators of hydraulic system 56, if desired, such as a common spool valve associated with each side of individual actuators or a single spool valve for each actuator, as desired.

In some embodiments, metering valves 76-82 may be used to facilitate fluid regeneration within the associated linear actuator. For example, when metering valves 76 and 82 are simultaneously moved to their flow-passing positions and metering valves 78 and 80 are in their flow-blocking positions, high-pressure fluid may be transferred from one chamber to the other of the linear actuator via metering valves 76 and 82, with only the rod volume of fluid (i.e., the volume displaced by rod portion 50A that is about equal to a difference between a first chamber volume and a second chamber volume) ever passing through pump 66. Similar functionality may alternatively be achieved by moving metering valves 78 and 80 to their flow-passing positions while holding metering valves 76 and 82 in their flow-blocking positions.

Each of the remaining actuators within hydraulic system 56 (i.e., the actuators not equipped with a set of metering valves 76-82) may be provided with a switching valve 83. Switching valve 83 may be capable of selectively switching a flow direction of fluid passing through the associated actuator such that, for a given flow of fluid in a single direction, the actuator may be moved in two different directions. In exemplary embodiments, switching valves 83 may also be capable of substantially isolating an associated rotary or linear actuator from its corresponding pump 66 and/or other hydraulic circuit components.

Switching valves 83 may each embody a substantially identical, three-position, variably actuated valve. In particular, each switching valve 83 may be solenoid-actuated between two different flow-passing positions and one flow-blocking position. The different flow-passing positions may include, for example, a direct-flow position and a cross-flow position, wherein the cross-flow position may direct fluid in a direction opposite or reversed from the direct-flow position. When switching valve 83 is in one of the flow-passing positions, fluid may flow substantially unrestricted through left and right pump passages 68, 70 into and out of the rotary or linear actuators. When switching valve 83 is in the flow-blocking position, fluid flows within left and right pump passages 68, 70 may not pass into, out of, or through the rotary or linear actuators to substantially affect the motion of the rotary or linear actuator. Switching valves 83 may be spring-biased toward the flow-blocking position. It is contemplated that switching valves 83 may also function as load-holding valves, hydraulically locking movement of the rotary and/or linear actuators. Such hydraulic locking may occur when, for example, the associated actuators have non-zero displacement and switching valves 83 are in their flow-blocking positions.

Variable position switching valves 83 may be configured to controllably vary the amount of fluid passing therethrough. The flow rates may vary between a substantially unrestricted flow at a fully open flow-passing position, and a completely restricted flow (i.e., no flow) at a fully closed flow-blocking position. In such exemplary embodiments, switching valves 83 may be configured to controllably vary, increase, decrease, and/or otherwise change a linear or rotational speed of the associated actuators, in addition to facilitating isolation and/or selective flow direction switching of the associated actuators. Such switching valves 83 may be configured to change the respective speeds of the associated actuators independently by restricting flow through the associated actuators.

For example, there may be times when one of pumps 66 provides fluid to more than one actuator simultaneously (see circuits 58 and 62). In such applications, it may be desirable to change a speed of one of the actuators without changing a speed of the remaining actuators receiving fluid from pump 66, and a variable position switching valve 83 may be configured to independently change the speed of its associated actuator by variably restricting the flow of fluid through the actuator. Such flow and/or speed control may be useful when, for example, independently changing the speed of hydraulic cylinders 26 and/or hydraulic cylinder 34 when pump 66 of hydraulic circuit 62 is providing fluid to each of these actuators simultaneously. It is understood that the flow of fluid through each of circuits 58 and 62 may be controlled by the associated pump 66, and as this flow passes through respective switching valves 83, changing the conductance that switching valve 83 imposes on this flow may have the effect of altering the pressure difference across the switching valve 83. Thus, for a given flow passing through switching valve 83 to a respective actuator, such a change in conductance may dictate the speed of the actuator if the pressures balance the load being applied to the actuator.

In some situations, it may be desirable to combine fluid from one circuit with fluid from another circuit to increase a flow rate of fluid directed to and a resulting speed of a particular actuator. For example, there may be situations where the capacity of pump 66 of first circuit 58 is too low to supply a combined demand for pressurized fluid from hydraulic cylinder 32 and right-travel motor 42R. There may also be situations where the capacity of pump 66 of second circuit 60 is too low for a maximum demand for pressurized fluid from swing motor 43. In these situations, as well as in others, it may be helpful to combine fluid flows from pumps 66 of both first and second circuits 58, 60 and to direct the combined flows to hydraulic cylinder 32, right-travel motor 42R, or to swing motor 43 to increase a speed of the particular actuator. For this reason, hydraulic system 56 may be provided with one or more combining valves 84.

In the disclosed exemplary embodiment, hydraulic system 56 includes four different combining valves 84. Specifically, a first combining valve 84A may be disposed between first and second circuits 58, 60; a second combining valve 84B may be disposed between first and fourth circuits 58, 64; a third combining valve 84C may be disposed between third and fourth circuits 62, 64, and a fourth combining valve 84D may be disposed between second and fourth circuits 60, 64.

Each combining valve 84 may be configured to control fluid flow within a first common passage 86 that extends between left pump passages 68 of the connected circuits, and within a second common passage 88 that extends between right pump passages 70. In the embodiment of FIG. 2, combining valve 84 may include a single variable-position valve element 90 that is movable to any position between a first or flow-blocking position (shown in FIG. 2) and a second or flow-passing position. Valve element 90 may be spring-biased toward the first position and solenoid-operated to move toward the second position. When valve element 90 is in the first position, the paired circuits may be substantially isolated from each other. When valve element 90 is in the second position, fluid may flow freely between left pump passages 68 and between right pump passages 70 of the paired circuits. A direction of flow through combining valve 84 may be determined, at least in part, by a pressure differential between the circuits.

It is contemplated that one or more of combining valves 84 may be replaced with a pair of single-passage control valves 91, if desired. Control valves 91 may each be an on-off type of valve associated with a single passage. In the disclosed embodiment, hydraulic system 56 includes three different control valves 91. For example, a first control valve 91A may be located within a first common passage 86 that extends between left pump passages 68 of first and fifth circuits 58, 65; a second control valve 91B may be located within a second common passage 88 that extends between right pump passages 70 of first and fifth circuits 58, 65; and a third control valve 91C may be located within a first common passage 86 that extends between fourth and fifth circuits 64, 65. Control valves 91 may function similar to combining valves 84 by selectively fluidly communicating the paired circuits, but do so via control over a single passage.

During operation of machine 10, the operator may utilize interface device 46 to provide a signal that identifies a desired movement of the various linear and/or rotary actuators to a controller 92. Based upon one or more signals, including the signal from interface device 46 and, for example, signals from various pressure and/or position sensors located throughout hydraulic system 56, controller 92 may command movement of the different valves and/or displacement changes of the different pumps to advance a particular one or more of the linear and/or rotary actuators to a desired position in a desired manner (i.e., at a desired speed and/or with a desired force).

Controller 92 may embody a single microprocessor or multiple microprocessors that include components for controlling operations of hydraulic system 56 based on input from an operator of machine 10 and based on sensed or other known operational parameters. Numerous commercially available microprocessors can be configured to perform the functions of controller 92. It should be appreciated that controller 92 could readily be embodied in a general machine microprocessor capable of controlling numerous machine functions. Controller 92 may include a memory, a secondary storage device, a processor, and any other components for running an application. Various other circuits may be associated with controller 92 such as power supply circuitry, signal conditioning circuitry, solenoid driver circuitry, and other types of circuitry.

### INDUSTRIAL APPLICABILITY

The disclosed hydraulic system may be applicable to any machine where improved hydraulic efficiency and performance is desired. The disclosed hydraulic system may provide for improved efficiency through the use of closed loop and meterless technology. The disclosed hydraulic system may provide for enhanced functionality and control through the selective use of novel circuit and flow-combining configurations. Operation of hydraulic system 56 will now be described.

During operation of machine 10, an operator located within station 20 may command a particular motion of work tool 14 in a desired direction and at a desired velocity by way of interface device 46. One or more corresponding signals generated by interface device 46 may be provided to controller 92 indicative of the desired motion, along with machine performance information, for example sensor data such a pressure data, position data, speed data, pump displacement data, and other data known in the art.

In response to the signals from interface device 46 and based on the machine performance information, controller 92 may generate control signals directed to pumps 66, motors 42L, 42R, 43, and 67, and/or to valves 76, 78, 80, 82, 83, 90, 91. For example, to rotate right-travel motor 42R at an increasing speed in the first direction, controller 92 may generate a control signal that causes pump 66 of first circuit 58 to increase its displacement and discharge fluid into right pump passage 70 at a greater rate. In addition, controller 92 may generate a control signal that causes switching valve 83 to move toward and/or remain in one of the two flow-passing positions. After fluid from right pump passage 70 passes into and through right-travel motor 42R, the fluid may return to pump 66 via left pump passage 68. At this time, the speed of right-travel motor 42R may be dependent on a discharge rate of pump 66 and on a restriction amount, if any, provided by switching valve 83 on the flow of fluid passing through right-travel motor 42R. Movement of right travel motor 42R may be reversed by moving switching valve to the other of the two flow-passing positions.

Hydraulic cylinder 32 may be moved simultaneous with and/or independent of right travel motor 42R. In particular, while right travel motor 42R is receiving fluid from pump 66, metering valve 78 or metering valve 80 may be moved to divert some of the fluid into first or second chamber 52, 54 of hydraulic cylinder 32. At this same time, metering valve 76 and/or 82 may be moved to direct waste fluid from hydraulic cylinder 32 back to pump 66. When switching valve 83 and the appropriate metering valves 76-82 are fully open, the movements of right travel motor 42R and hydraulic cylinder 32 may be linked and dependent on the flow rate of fluid from pump 66.

In order to provide for independent control over the speed of right travel motor 42R and hydraulic cylinder 32, the fluid flowing into and/or out of at least one of these actuators must be metered. For example, switching valve 83 and/or metering valves 76-82 may move to intermediate positions at which fluid flow therethrough is restricted to some degree. When this occurs, the speed of one or both of the actuators may be modulated as desired. Operation of hydraulic cylinders 26 and 34 and of left-travel, swing, and auxiliary motors 42L, 43, 67 may be implemented in a similar manner to that described above. Accordingly detailed description of the individual movements of these actuators will be not be described in this disclosure.

During some operations, the flow rate of fluid provided to individual actuators from their associated pumps 66 may be insufficient to meet operator demands. For example, during a boom raising operation by hydraulic cylinders 26, an operator may request a speed of machine 10 that would require a flow rate of fluid within fourth circuit 64 that exceeds the capacity of the associated pump 66. During this situation, controller 92 may cause the valve element(s) of the corresponding combining valve 84D to pass fluid from second circuit 60 to fourth circuit 64, thereby increasing the flow rate of fluid available to hydraulic cylinders 26. At this time, fluid discharging from hydraulic cylinders 26 may be returned to pump 66 of fourth circuit 64 and to pump 66 of second circuit 60 via combining valve 84D. Flow sharing between other circuits via other combining valves 84 may be implemented in a similar manner.

The sharing of fluid between second circuit 60 and fourth circuit 64 may be particularly beneficial due to circumstances during which fourth circuit 64 is typically in need of additional flow. Specifically, during a digging operation, hydraulic cylinders 26 may require extra flow and, at this same time, pump 66 of second circuit 60 may be idle at this time. Accordingly, the full capacity (flow rate and pressure control) of second circuit 60 may be available when most needed by fourth circuit 64. This may not always be the case with other circuits. For example, third circuit 62 may generally be in use providing fluid at a particular pressure to hydraulic cylinder 34 at the time that fourth circuit 64 is most in need of fluid. Sharing fluid between third circuit 62 and fourth circuit 64 at this time may be inefficient, provide little benefit, and/or reduce control over fourth circuit operation.

Flow sharing may also be selectively implemented when an amount of fluid discharged from one actuator exceeds a rate at which the corresponding pump 66 can efficiently consume return fluid. For example, during a boom lowering operation, when boom 22 is moving under the force of gravity, fluid may be discharged from first chambers 52 of hydraulic cylinders 26 at high pressure. Some of this discharging fluid may be redirected via metering valves 76 and 82 back into second chamber 54 of hydraulic cylinders 26. This operation may be known as regeneration, and results in an efficiency improvement over pump supplied fluid being directed into second chambers 54. During regeneration, however, the amount of fluid being discharged from first chambers 52 is greater than the amount of fluid entering second chambers 54, due to the presence of rod-portions 50A within second chambers 54. Accordingly, this extra fluid exiting first chambers 52 must be consumed somewhere. In the disclosed embodiment, the extra fluid discharging from hydraulic cylinders 26 during boom down movements may be directed through pump 66 of fifth circuit 65 (e.g., via first common passage 86 and control valve 91C). This extra high-pressure fluid may be used to drive pump 66 as a motor, thereby returning energy to hydraulic system 56.

In the disclosed embodiments of hydraulic system 56, flows provided by pumps 66 may be substantially unrestricted during many operations such that significant energy is not unnecessarily wasted in the actuation process. Thus, embodiments of the disclosure may provide improved energy usage and conservation. In addition, the ability to combine fluid flows from different circuits to satisfy demands of individual actuators may allow for a reduction in the number of pumps required within hydraulic system 56 and/or a size and capacity of these pumps. These reductions may reduce pump losses, improve overall efficiency, improve packaging of hydraulic system 56, and/or reduce a cost of hydraulic system 56.

It will be apparent to those skilled in the art that various modifications and variations can be made to the disclosed hydraulic system. Other embodiments will be apparent to those skilled in the art from consideration of the specification and practice of the disclosed hydraulic system. It is intended that the specification and examples be considered as exemplary only, with a true scope being indicated by the following claims and their equivalents.

What is claimed is:

1. A hydraulic system, comprising:
a first pump;
a boom cylinder;
a first closed loop fluidly connecting the first pump to the boom cylinder;
a second pump;
a swing motor;
a second closed loop fluidly connecting the second pump to the swing motor;
a third pump;
an auxiliary actuator;
a third closed loop fluidly connecting the third pump to the auxiliary actuator;
a combining valve configured to selectively connect the second closed loop to the first closed loop during a boom raising operation; and
a control valve configured to selectively connect the third closed loop to the first closed loop during a boom lowering operation.

2. The hydraulic system of claim 1, further including a travel motor fluidly connected to the first pump via the first closed loop.

3. The hydraulic system of claim 2, further including a plurality of metering valve disposed between the boom cylinder and the first pump.

4. The hydraulic system of claim 3, further including a switching valve disposed between the travel motor and the first pump.

5. The hydraulic system of claim 4, wherein:
the switching valve is a first switching valve; and
the hydraulic system further includes a second switching valve disposed between the swing motor and the second pump.

6. The hydraulic system of claim 1, wherein:
the combining valve is configured to connect supply and return passages of the second closed loop to supply and return passages of the first closed loop; and
the control valve is configured to connect only a return passage of the third closed loop to a return passage of the first closed loop.

7. The hydraulic system of claim 1, wherein:
the combining valve is a first combining valve; and
the hydraulic system further includes:
a fourth pump;
a bucket cylinder;
a fourth closed loop fluidly connecting the fourth pump with the bucket cylinder; and
a second combining valve configured to selectively connect the fourth closed loop with the first closed loop.

8. The hydraulic system of claim 1, wherein:
the combining valve is a first combining valve; and
the hydraulic system further includes:
a fourth pump;
a stick cylinder;
a fourth closed loop fluidly connecting the fourth pump with the stick cylinder; and
a second combining valve configured to selectively connect the fourth closed loop with the first closed loop.

9. The hydraulic system of claim 8, further including a third combining valve configured to selectively connect the second closed loop and the fourth closed loop.

10. The hydraulic system of claim 9, further including a plurality of metering valve disposed between the stick cylinder and the fourth pump.

11. The hydraulic system of claim 10, further including a travel motor fluidly connected to the fourth pump via the fourth closed loop.

12. The hydraulic system of claim 11, further including a switching valve disposed between the travel motor and the fourth pump.

13. The hydraulic system of claim 8, wherein:
the control valve is a first control valve; and
the hydraulic system further includes at least a second control valve configured to selectively connect the third closed loop with the fourth closed loop.

14. The hydraulic system of claim 13, wherein the at least a second control valve includes:
a second control valve configured to selectively connect a supply passage of the third closed loop with a supply passage of the fourth closed loop; and
a third control valve configured to selectively connect a return passage of the third closed loop with a supply passage of the fourth closed loop.

15. The hydraulic system of claim 1, wherein the first, second, and third pumps are each variable displacement, unidirectional pumps.

16. A hydraulic system, comprising:
a first pump, a boom cylinder, and a first travel motor fluidly connected to each other in a first closed loop;
a second pump and a swing motor fluidly connected to each other in a second closed loop;
a third pump and an auxiliary actuator fluidly connected to each other in a third closed loop;
a fourth pump and a bucket cylinder fluid connected to each other in a fourth closed loop;
a fifth pump, a stick cylinder, and a second travel motor fluidly connected to each other in a fifth closed loop;
a first combining valve configured to selectively connect the second closed loop to the first closed loop during a boom raising operation;
a second combining valve configured to selectively connect the fourth closed loop with the first closed loop;
a third combining valve configured to selectively connect the fifth closed loop with the first closed loop;
a fourth combining valve configured to selectively connect the fifth closed loop and the second closed loop;
a first control valve configured to selectively connect a return passage of the third closed loop to a return passage of the first closed loop during a boom lowering operation;
a second control valve configured to selectively connect a supply passage of the third closed loop with a supply passage of the first closed loop; and
a third control valve configured to selectively connect a supply passage of the third closed loop with a supply passage of the first closed loop.

17. A method of operating a hydraulic system, comprising:
pressurizing fluid with a first pump;
directing pressurized fluid from the first pump into and out of a boom cylinder via a first closed loop to move the boom cylinder;
pressurizing fluid with a second pump;
directing pressurized fluid from the second pump through a swing motor via a second closed loop to move the swing motor;
pressurizing fluid with a third pump;
directing pressurized fluid from the third pump into and out of an auxiliary actuator to move the auxiliary actuator;
selectively directing pressurized fluid from the second pump into of the boom cylinder during a boom raising operation; and
selectively directing fluid from the boom cylinder to the third pump during a boom lowering operation.

18. The method of claim 17, further including directing pressurized fluid from the first closed loop through a first travel motor.

19. The method of claim 18, further including:
pressurizing fluid with a fourth pump;
directing pressurized fluid from the fourth pump into and out of a bucket cylinder via a fourth closed loop to move the bucket cylinder; and
selectively directing pressurized fluid from the fourth pump into the boom cylinder.

20. The method of claim 19, further including:
pressurizing fluid with a fifth pump;
directing pressurized fluid from the fifth pump into and out of a stick cylinder and a second travel motor via a fifth closed loop to move the stick cylinder and the second travel motor; and
selectively directing pressurized fluid from the fifth pump into the boom cylinder.
